(19) United States
(12) Patent Application Publication
(10) Pub. No.: US 2008/0217565 A1
(43) Pub. Date: Sep. 11, 2008

(54) SUCKER ROD PUMP WITH IMPROVED BALL CONTAINMENT VALVE CAGE

(76) Inventor: Michael Brent Ford, St. George, UT (US)

Correspondence Address: WEISS & MOY PC, 4204 NORTH BROWN AVENUE, SCOTTSDALE, AZ, 85251, US

(21) Appl. No.: 11/684,204

(22) Filed: Mar. 9, 2007

(51) Int. Cl. F16K 15/04

(52) U.S. Cl. 251/120

(57) ABSTRACT

There is provided, in one embodiment, a ball valve for regulating the flow of petroleum fluids therethrough. The ball valve is capable of transitioning between an open and a closed position. The ball valve includes a lower cage and an upper cage. A common cage channel runs between the upper and lower cage and can be aligned along a central cage axis. Petroleum fluids can pass through the cage channel. The lower cage also includes an annular wall disposed thereon and a ball seat positioned on the lower cage. A ball disposed in the valve can position itself off and on the ball seat in order to open and close the valve. The upper cage, which attaches to the lower cage, defines a plurality of apertures; as petroleum fluids pass through the apertures, the apertures impart a cyclonic rotation on the fluid. A chamber wall is also connected to the upper cage, the chamber wall defining a ball retaining chamber. The ball rests in the ball retaining chamber when the ball valve is in the open position. An annular flow space is defined by the chamber wall and the annular wall, and the annular flow space is positioned around the ball retaining chamber. The annular flow space receives petroleum fluid from the lower cage channel and transmits petroleum fluid to the upper cage channel. The upper cage may also define a ball hole providing fluid communication between the upper cage channel and the ball retaining chamber.

### FIELD OF THE INVENTION

The present invention relates to mechanical oil pumps actuated by sucker rod reciprocation. More particularly, the invention relates to the directional control of oil flow through the oil pump and to the positioning of ball and seat components within the oil pump.

### BACKGROUND OF THE INVENTION

As the natural pressure in a completed oil well gradually depletes, the well may require a means known as artificial lift to continue the flow of petroleum reserves from their subterranean location to the earth's surface. Various forms of artificial lift are known including, for example, gas injection, water injection, and mechanical pumping. Petroleum engineers select a form of artificial lift depending on a number of criteria including, for example, formation geology and economics. The sucker rod pump is a well-known kind of mechanical pump that is widely used in the petroleum industry.

The sucker rod pumping system typically includes a means of providing a reciprocating (up and down) mechanical motion located at the surface near the well head. A string of sucker rods up to more than a mile in length—is connected to the mechanical means. The sucker rod string is fed through the well tubing down hole where it is connected to the pump.

As is generally known in the art, a sucker rod pump includes at least two separate valves as well as other pump components such as a barrel, plunger, and anchor. Beginning at the south end, oil pumps generally include a standing valve, which has a ball therein, the purpose of which is to regulate the passage of oil (or other substance being pumped) from downhole into the pump, allowing the pumped matter to be moved northward out of the system and into the flow line, while preventing the pumped matter from dropping back southward into the hole. Oil is permitted to pass through the standing valve and into the pump by the movement of the ball off its seat, and oil is prevented from dropping back into the hole by the seating of the ball. North of the standing valve, coupled to the sucker rod, is a traveling valve. The purpose of the traveling valve is to regulate the passage of oil from within the pump northward in the direction of the flow line, while preventing the pumped oil from dropping back in the direction of the standing valve and hole.

Actual movement of the pumped substance through the system will now be discussed. Oil is pumped from a hole through a series of “downstrokes” and “upstrokes” of the oil pump, which motion is imparted by the above-ground pumping unit. During the upstroke, formation pressure causes the ball in the standing valve to move upward, allowing the oil to pass through the standing valve and into the barrel of the oil pump. This oil will be held in place between the standing valve and the traveling valve. In the traveling valve, the ball is located in the seated position, held there by the pressure from the oil that has been previously pumped.

On the downstroke, the ball in the traveling valve unseats, permitting the oil that has passed through the standing valve to pass therethrough. Also during the downstroke, the ball in the standing valve seats, preventing pumped oil from moving back down into the hole. The process repeats itself again and again, with oil essentially being moved in stages from the hole, to above the standing valve and in the oil pump, to above the traveling valve and out of the oil pump. As the oil pump fills, the oil passes through the pump and into the tubing. As the tubing is filled, the oil passes into the flow line, from which oil is taken to a storage tank or other such structure.

Presently known designs of sucker rod pumps suffer from several shortcomings in various areas of the design. The ball and seat components used in both the traveling valve and the standing valve are exposed to wear. The seat components are also subject to high pressures, particularly in deep wells, which can lead to cracking. Hence, it would be desired to develop sucker rod pumps having valves that display improved wear and cracking resistance.

A further disadvantage of presently-known sucker rod pump designs relates to sand control. Sand that is often produced along with petroleum can clog and foul pump components. Once sand enters the pump at a bottom, or southward, position, the sand must be managed in the pump apparatus. Hence, it would be desired to provide a sucker rod pump with improved sand control features. Further, it would be desired to limit sand or solids from entering the pump at the pump's lower position.

Still a further disadvantage of known sucker rods relates to the flow of petroleum and fluids through the pump. Pumps typically allow for the turbulent flow of fluids at high pressures. This turbulent flow promotes wear of pump components. It would be desired to provide a sucker rod pump with an improved flow control.

Hence there has been identified a need to provide an improved sucker rod pump and components therein. It is desired that the sucker rod pump be robust and provide an improved service life over known pumps, and thereby that the sucker rod pump provide an improved cost performance. It would further be desired that the sucker rod pump provide an improved pumping efficiency. It would also be desired that an improved sucker rod pump be compatible with existing petroleum production devices. The present invention addresses one or more of these needs.

### SUMMARY OF THE INVENTION

In one embodiment, and by way of example only, there is provided a ball valve for regulating the flow of petroleum fluids therethrough. The ball valve is capable of transitioning between an open and a closed position. The ball valve includes a lower cage and an upper cage. A common cage channel runs between the upper and lower cage and can be aligned along a central cage axis. Petroleum fluids can pass through the cage channel. The lower cage also includes an annular wall disposed thereon and a ball seat positioned on the lower cage. A ball disposed in the valve can position itself off and on the ball seat in order to open and close the valve. The upper cage, which attaches to the lower cage, defines a plurality of apertures; as petroleum fluids pass through the apertures, the apertures impart a cyclonic rotation on the fluid. A chamber wall is also connected to the upper cage, the chamber wall defining a ball retaining chamber. The ball rests in the ball retaining chamber when the ball valve is in the open position. An annular flow space is defined by the chamber wall and the annular wall, and the annular flow space is positioned around the ball retaining chamber. The annular flow space receives petroleum fluid from the lower cage channel and transmits petroleum fluid to the upper cage channel. The upper cage may also define a ball hole providing fluid communication between the upper cage channel and the ball retaining chamber.

Other independent features and advantages of the sucker rod pump with ball containment valve cage will become apparent from the following detailed description, taken in conjunction with the accompanying drawings which illustrate, by way of example, the principles of the invention.

### BRIEF DESCRIPTION OF THE DRAWINGS

FIG. 1 is a cut away view of an improved ball containment cage, according to an embodiment of the present invention.

FIG. 2 is a top view of the ball containment cage, according to an embodiment of the present invention.

FIG. 3A is a perspective, cross-sectional view of a ball retaining chamber component of a ball containment cage, according to an embodiment of the present invention.

FIG. 3B is a perspective view of a ball retaining chamber component of a ball containment cage, according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

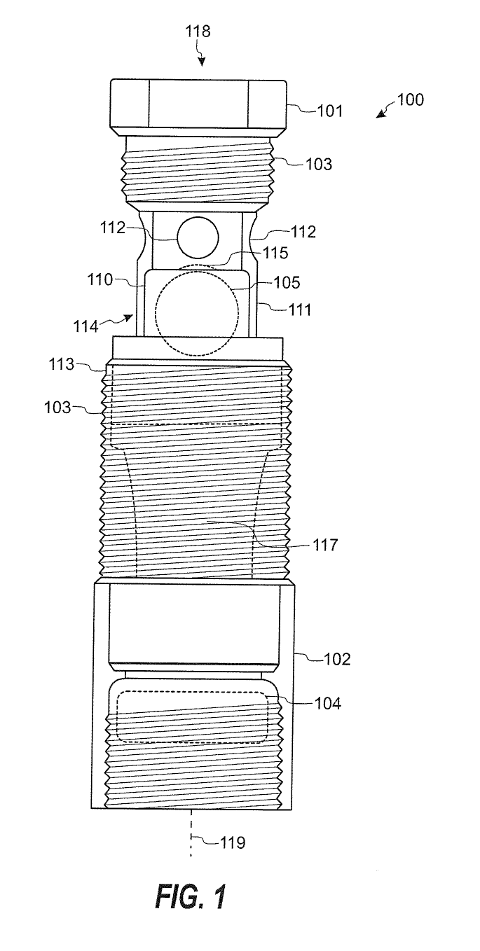

Referring first to FIG. 1 there is illustrated an embodiment of a valve cage 100 according to an embodiment of the present invention. In a preferred embodiment cage 100 comprises an upper cage 101 and lower cage 102 although it is possible to create cage 100 as a unitary piece. Upper cage 101 and lower cage 102 may be joined by a variety of means including the illustrated means of reciprocal threading 103. The joining of upper cage 101 and lower cage 102 creates cage 100 which is the housing in which a seat 104 and ball 105 can be positioned so as to form a ball valve, such as a standing valve or traveling valve in a sucker rod pump. Lower cage 102 may include a structure such as a seat rest to receive seat 104. Upper cage 101 may also include a structure within ball retaining chamber 111 that acts to seat against ball 105 when ball 105 moves into chamber 111.

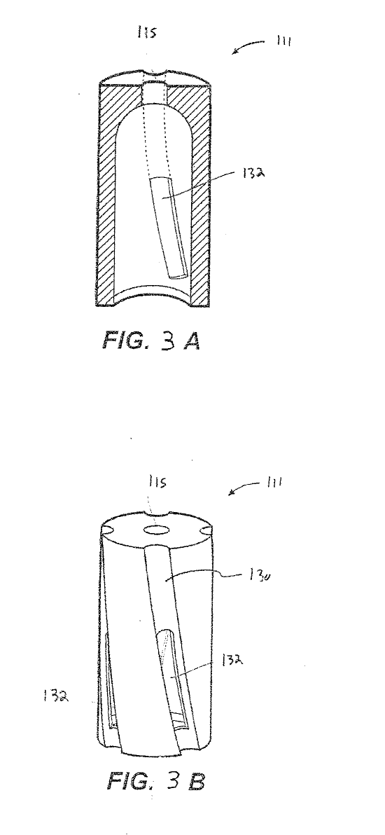

Still referring to FIG. 1 cage 100 may include various features which will now be discussed. Upper cage 101 includes a chamber wall 110 which defines a ball retaining chamber 111 (see also FIGS. 3A and 3B, discussed below). Ball retaining chamber 111 is sized so that ball 105 can freely enter and exit chamber 111. Upper cage 101 may also include a plurality of apertures 112 through which petroleum fluids may travel. Additionally upper cage 101 includes ball hole 115 on an upper surface of ball retaining chamber 111. Lower cage 102 includes an annular wall 113. When upper cage 101 is fully joined to lower cage 102 an annular flow space 114 is defined between the annular wall 113 (of lower cage 103) and the chamber wall 110 (of upper cage 101). Petroleum fluids can pass through annular flow space 114 to apertures 112.

In a preferred embodiment cage 100 is generally cylindrical in shape although it can take a variety of geometric configurations. When cylindrical, cage 100 is aligned along central cage axis 119. Lower cage 102 defines a lower cage channel 117, and upper cage 101 defines an upper cage channel 118. Lower cage channel 117 and upper cage channel 118 are preferably aligned along central cage axis 119.

In a preferred embodiment, chamber wall 110 is partially cylindrical in shape with an inner surface and an outer surface. The inner surface of chamber wall 110 defines ball retaining chamber 111. The outer surface of chamber wall 110 defines one boundary of annular flow space 114. Thus it is preferred that the radius of outer surface of chamber wall 110 is less than the radius of annular wall 113.

Referring now to FIGS. 3A and 3B, an embodiment of the ball retaining chamber 111 is described in greater detail. Preferably, a plurality of angled flutes 130 are positioned around ball retaining chamber 111. In one embodiment, the flutes 130 are open at a lower portion 132 therefore, so as to permit the passage of fluid therethrough. As best seen in FIG. 3A, an upper, interior portion of the ball retaining chamber 111 is preferably rounded, so as to provide smoother contact between the rising ball 105 and the top of the ball retaining chamber 111.

In operation, petroleum fluids pass from a lower region of a pump line to an upper region through a cyclic repetition of upstrokes and downstrokes. Beginning with a downstroke, fluid passes upward through lower cage channel 117. Fluids moving in an upward direction push ball 105 off seat 104. Fluids passing upward through ball retaining chamber 111 will exit lower portion 132 of flutes 130, imparting a spinning motion on ball 105 and thereby providing for a more controlled upward motion of the ball 105, reducing wear and tear on the ball 105. The spinning motion also facilitates the removal of solids on the ball 105, which could if not removed interfere with the seating of the ball 105. The ball 105 will rise within the ball retaining chamber 111 until it is cupped in the uppermost interior portion thereof.

When ball 105 is positioned in ball retaining chamber 111, the valve is in the open position. Fluids passing upward through lower cage channel 117 are obstructed when they reach ball 105 and are forced around ball 105 into annular flow space 114. Fluids freely move in an upward direction through annular flow space 114 until reaching apertures 112. Fluid then passes through apertures 112 into upper cage channel 118. In upper cage channel 118, the fluid continues its upward movement.

When an upstroke of the pump occurs, fluids momentarily reverse direction of flow relative to cage 100. Fluid in upper cage channel 118 now moves in a downward direction. This fluid impacts against ball 105 through ball hole 115 which acts to quickly push ball 105 out of ball retaining chamber 111 in a downward direction and against seat 104. There should be little or no spinning motion on the ball 105 during its downward travel. When ball 105 is lodged against seat 104 the valve is in the closed position. When in the closed position, fluid can no longer move downward past ball 105, and fluid positioned above ball 105 is stationary relative to the valve. At this point fluid is carried upward as pump continues its upstroke. Fluid that is positioned below ball is sucked upward by the upward movement of pump, thus pulling additional fluid from the formation into the lower portions of the pump string.

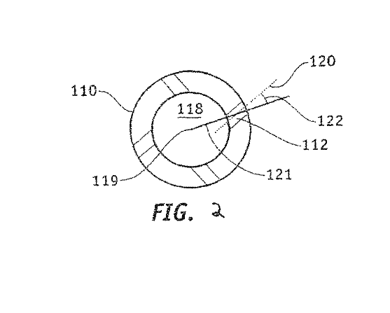

Referring now to FIG. 2, it is noted that apertures 112 are oriented so as to impart a cyclonic rotation on the fluids as they pass through apertures 112 and into upper cage channel 118. Apertures 112 are preferably formed by a drilling operation so that apertures 112 themselves are cylindrical in shape and are thus aligned along an aperture axis 120. However, apertures 112 need not be cylindrical, and may be curved in shape, so long as aperture 112 imparts a cyclonic motion on fluid that passes through the aperture. When aperture 112 is aligned along an aperture axis 120, the aperture axis 120 is set at some angle 122 offsetting a normal line 121 extending from central cage axis 119 to the center point of aperture 112. Apertures 112 can have any vertical alignment with respect to a plane normal to central cage axis 119.

It is preferred that cyclonic rotation in the upper cage 101 be counterclockwise, viewed from above, in the northern hemisphere, and clockwise, viewed from above, in the southern hemisphere.

One of the advantages of the present cage 100 is related to the ball retaining chamber 111. In prior art cages, a ball is allowed room for movement in its cage. As fluid passes upward around ball in turbulent flow, the ball is violently shaken in all directions. The ball pounds repeatedly and violently against its surrounding cage. As a result of this pounding, the ball and surrounding cage is subject to wear. Further, the turbulent flow of fluids around the ball is a relatively inefficient way to move fluids.

In contrast, in the present invention, ball 105 is calmly held in a stable position in ball retaining chamber 111. Ball retaining chamber 111 is structured so as to hold the ball 105 when in the open position. The ball 105 is limited in its upper movement and side-to-side movement, and the imparting of a spinning motion during upward travel provides cleaning and control benefits. Thus it is desired to structure ball retaining chamber 111 with a diameter that is slightly larger than the diameter of ball 105. Further, it is desired to extend chamber wall 110 sufficiently far downward so that, as ball 105 leaves seat 104 ball 105 must enter ball retaining chamber 111. Thus the structure of ball retaining chamber 111 maintains ball 105 in a still position, compared to prior art devices, and avoids the wear that occurs with prior art devices.

It is further noted that ball retaining chamber 111 includes features that avoid ball 105 becoming stuck in chamber 111. As mentioned above, ball retaining chamber 111 is preferably dimensioned slightly larger than ball 105. Additionally, the upper surface of ball retaining chamber 111 includes ball hole 115; ball hole 115 provides fluid communication between upper cage channel 118 and ball retaining chamber 111. When the pump begins an upstroke, fluid in upper cage channel 118 changes direction of momentum. Fluid thus impacts a surface of ball 105 through ball hole 115. This dislodges ball 105 from ball retaining chamber 111 and allows ball 105 to reseat itself against seat 104. Ball hole 115 is further sized so that during a downstroke, ball 105 rests in ball retaining chamber 111, closing ball hole 105, so as to substantially prevent the upward movement of fluid through ball hole 105. Rather fluid is forced around ball 105, through annular flow space 114, and through apertures, 112 into upper cage channel 118. The method by which ball 105 is dislodged from ball retaining chamber 111 also represents an advantage of the cage relating to efficiency. Efficiency of the valve and pump is increased because ball 105 is dropped immediately. Forces to dislodge ball 105 come from a position directly over ball 105 and tend to move ball 105 linearly toward seat 104.

An additional advantage of the present invention relates to the cyclonic flow of fluids through cage 100. As previously stated, apertures 112 impart a cyclonic, rotational movement of fluids as they pass through apertures 112 into upper cage channel 118. This kind of flow is a more efficient and advantageous method of transporting petroleum fluids, as compared to the prior art method of turbulent flow. One advantage relates to the pressure gradient that is set up in such cyclonic flow patterns. The rotational movement of the fluid tends to create a high pressure toward the outer diameter of the cyclone and a lower pressure toward the inner diameter of the cyclone. Due to density differences in the components of the petroleum fluid, solids and heavy material are forced more to the outer diameter. Lighter liquids and gases are forced more to inner diameter. Within gas, liquid will tend to be outside of the inner gas. The density difference creates the separation.

Thus the cyclonic effect tends to concentrate the fluid into solid/heavy regions and liquid/light regions. This separation, during the pumping process, can assist in the separation of materials that takes place at the surface. Materials are more readily separated at the surface when they have been partially separated through cyclonic, centrifuge-type motion. Moreover, the cyclonic movement also addresses the issue of emulsification of petroleum fluids. Cyclonic rotation of the fluids in the valve tends to separate fluid components thereby discouraging emulsification.

When a series of cyclonic elements are used, there is an additional advantage with respect to ball wear. When a lower element imparts a cyclonic motion on fluid that impacts a ball, it tends to rotate the ball. Thus, the surface on which the ball contacts its retainer tends to move because the ball moves.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ball valve cage for transmitting fluid comprising:
an upper cage;
wherein the upper cage defines a plurality of apertures;
wherein the upper cage defines an upper cage channel;
a chamber wall disposed on the upper cage;
wherein the chamber wall defines a ball retaining chamber;
a lower cage connected with the upper cage to form the ball valve cage;
wherein the lower cage defines a lower cage channel;
an annular wall disposed on the lower cage; and
wherein the chamber wall and the annular wall define an annular flow space.

2. The ball valve cage according to claim 1 wherein the upper cage comprises threading and the lower cage comprises a reciprocal threading capable of receiving the top cage threading.

3. The ball valve cage according to claim 1 wherein the upper cage defines a ball hole providing fluid communication between the upper cage channel and the ball retaining chamber.

4. The ball valve cage according to claim 1 wherein the apertures are cylindrical in shape.

5. The ball valve cage according to claim 4 wherein the upper cage is aligned along a central cage axis, and wherein each aperture is aligned along an aperture axis such that the aperture axis forms an angle with a line extending from the central cage axis to the center opening of the aperture.

6. The ball valve cage according to claim 1 wherein the ball retaining chamber is rounded at an upper interior portion thereof.

7. The ball valve cage according to claim 1 wherein the ball retaining chamber further comprises a plurality of angled flutes positioned therearound, and wherein said flutes are open at a lower portion thereof.

8. The ball valve cage according to claim 1 wherein the fluid in the upper cage channel has a higher pressure at an outer diameter and a lower pressure at an inner diameter.

9. The ball valve cage according to claim 1 wherein the chamber wall further defines a plurality of spiral ridges projecting into the ball retaining chamber.

10. A ball valve for regulating the flow of petroleum fluids therethrough, the ball valve capable of transitioning between an open and a closed position, the ball valve comprising:
a lower cage defining a lower cage channel, the lower cage aligned along a central cage axis, and the lower cage channel capable of receiving petroleum fluids and transmitting petroleum fluids therethrough;
an annular wall disposed on the lower cage;
a ball;
a ball seat positioned on the lower cage, wherein the ball rests against the ball seat when the ball valve is in the closed position;
an upper cage attached to the lower cage, the upper cage defining a plurality of apertures; the upper cage further defining an upper cage channel, the upper cage aligned along the central cage axis, and the upper cage channel capable of receiving petroleum fluids through the apertures, and wherein the apertures impart a cyclonic rotation on fluid passing through the apertures into the upper cage channel;
a chamber wall connected to the upper cage, the chamber wall defining a ball retaining chamber, wherein the ball rests in the ball retaining chamber when the ball valve is in the open position; and
an annular flow space defined by the chamber wall and the annular wall, wherein the annular flow space is positioned around the ball retaining chamber, and wherein the annular flow space receives petroleum fluid from the lower cage channel and transmits petroleum fluid to the upper cage channel.

11. The ball valve cage according to claim 10 wherein the upper cage defines a ball hole providing fluid communication between the upper cage channel and the ball retaining chamber.

12. The ball valve cage according to claim 11 wherein fluid in the upper cage channel impacts upon the ball through the ball hole when the ball valve transitions to the closed position.

13. The ball valve cage according to claim 10 wherein the apertures are cylindrical in shape.

14. The ball valve cage according to claim 13 wherein the upper cage is aligned along a central cage axis, and wherein each aperture is aligned along an aperture axis such that the aperture axis forms an angle with a line extending from the central cage axis to the center opening of the aperture.

15. The ball valve according to claim 10 wherein the fluid in the upper cage channel has a higher pressure at an outer diameter and a lower pressure at an inner diameter.

16. The ball valve cage according to claim 10 wherein the upper cage comprises threading and the lower cage comprises a reciprocal threading capable of receiving the top cage threading.

17. The ball valve cage according to claim 10 wherein the chamber wall further defines a plurality of spiral ridges projecting into the ball retaining chamber.

18. A method for transmitting petroleum fluid through a ball valve capable of moving between an open position and a closed position, the method comprising the steps of:
positioning a ball in a ball retaining chamber so as to restrict movement of the ball and thereby placing the valve in an open position;
moving fluids around the ball into an annular flow space;
moving fluids through the annular flow space to an aperture; and
moving fluids through an aperture so as to impart a cyclonic rotation on the fluids.

19. The method according to claim 18 further comprising the step of moving fluid through a hole in the valve so as to release the ball from the ball retaining chamber.

20. The method according to claim 18 wherein the step of moving fluids through an aperture so as to impart a cyclonic rotation on the fluids further comprises moving the fluids through a substantially cylindrically shaped aperture wherein the aperture is aligned on an aperture axis and wherein the aperture axis is set at an angle offset from

21. The method according to claim 18 further comprising moving fluids through a plurality of apertures.

22. The method according to claim 18 wherein the step of moving fluids through an annular flow space further comprises moving fluids through an annular flow space defined by a chamber wall and an annular wall.

23. The method according to claim 18 further comprising wiping solids off of the ball during upward and downward movement of the ball utilizing the cyclonic rotation of the fluids as they pass the ball.
